(19) United States
(12) Patent Application Publication
(10) Pub. No.: US 2009/0072421 A1
(43) Pub. Date: Mar. 19, 2009

(54) METHOD FOR CUTTING SEMI-FINISHED MOLDING LENS

(75) Inventor: TSAI-SHIH TUNG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/146,849

(22) Filed: Jun. 26, 2008

(30) Foreign Application Priority Data
Sep. 14, 2007 (CN) 200710201715.3

(51) Int. Cl. B29D 11/00

(52) U.S. Cl. 264/2.7

(57) ABSTRACT

An exemplary method for cutting a semi-finished molding lens is provided. The semi-finished molding lens includes a lens portion, a runner forming portion, and a joint, the joint connected between the lens and the runner forming portion. The method includes the steps of: securing the semi-finished molding lens on a base; holding the lens portion by a suction force using a suction device; and cutting the lens portion off from the runner forming portion by a laser beam.

### BACKGROUND

1. Technical Field

The present invention relates to a method for cutting a semi-finished molding lens module into a plurality of lens units.

2. Description of Related Art

Nowadays, plastic lenses are widely used in consumer electronics products, for example, digital cameras, as they are cheap and simple to produce.

A method for producing plastic lenses generally includes the following steps: forming a semi-finished molding lens using an injection molding apparatus; and cutting the semi-finished molding lens using a cutting machine, thus obtaining a plurality of individual lenses. The cutting machine employs a pair of hot scissors to cut the semi-finished molding lens.

However, stress may be generated in the lens during the above mechanical cutting process, and remain in the lens after the cutting process. Because of the stress, the optical performance of the lens may deteriorate. Furthermore, a plurality of tiny plastic particles are generated and may be attached to surfaces of the lens. The particles may block light passing through the lens. Therefore, the optical performance of the lens may further deteriorate.

Therefore, a new method is desired to overcome the above mentioned problems.

### SUMMARY

An exemplary method for cutting a semi-finished molding lens is provided. The semi-finished molding lens includes a lens portion, a runner forming portion, and a joint connected between the lens portion and the runner forming portion. The method includes the steps of: securing the semi-finished molding lens on a base; holding the lens portion by a suction force using a suction device; and cutting the lens portion off from the runner forming portion by a laser beam.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, plan view of a semi-finished molding lens molded by injection molding.

FIG. 2 is a schematic, perspective view of a base with the semi-finished molding lens of secured therein.

FIG. 3 is a schematic, perspective view of a suction device sucking a lens portion of the semi-finished molding lens of FIG. 1.

FIG. 4 is a schematic, perspective view of a laser device emitting a laser towards the semi-finished molding lens of FIG. 1.

FIG. 5 is a schematic, perspective view of a lens collecting device for supporting a lens after being cut off from the semi-finished molding lens of FIG. 1.

### DETAILED DESCRIPTION OF THE EMBODIMENTS

Embodiments will now be described in detail below with reference to the drawings.

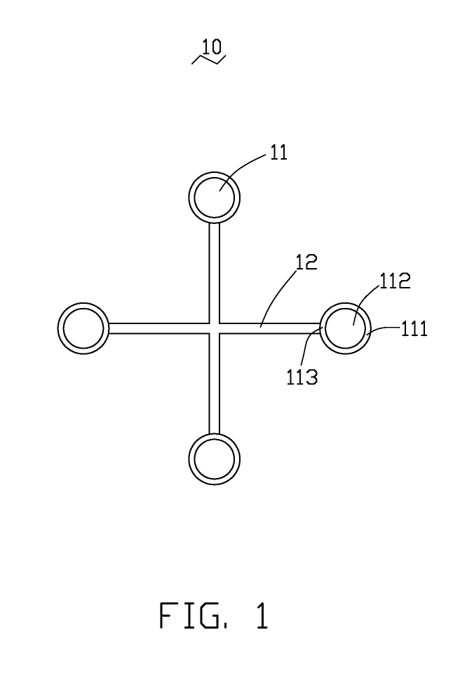

Referring to FIG. 1, a plastic semi-finished molding lens 10 formed by injection molding is shown. The semi-finished molding lens 10 includes a plurality of lens portions 11, a plurality of runner forming portion 12, and a plurality of joints 113. Each joint 113 is connected between a corresponding lens portion 11 and a corresponding runner forming portion 12. The lens portion 11 includes a central active part 112 and a peripheral inactive part 111 surrounding the active part 112.

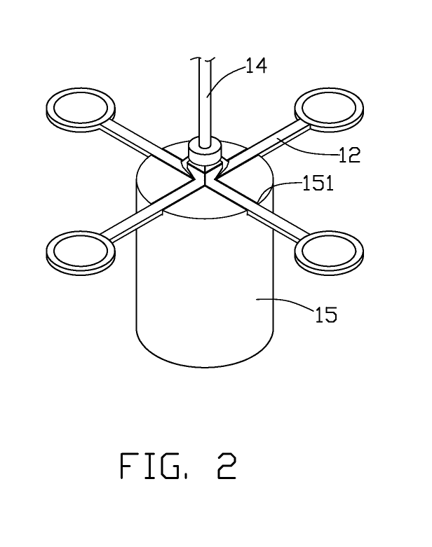

Referring to FIG. 2, the semi-finished molding lens 12 is clamped and carried to a base 15 by a machine arm 14. The base 15 has a plurality of recesses 151 defined therein. The recesses 151 are configured for accommodating the runner forming portions 12. The runner forming portions 12 are received in the recesses 151 so that the semi-finished molding lens 10 is secured in the base 15.

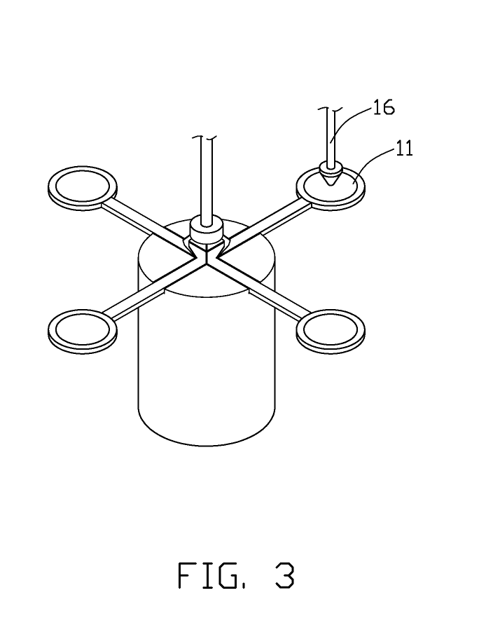

Referring to FIG. 3, the lens portions 11 are hold by a suction force using a suction device 16. In the present embodiment, the suction device 16 is a suction nozzle.

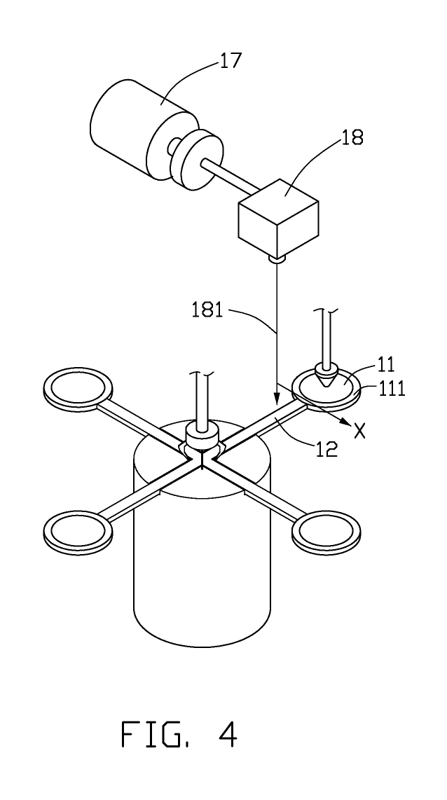

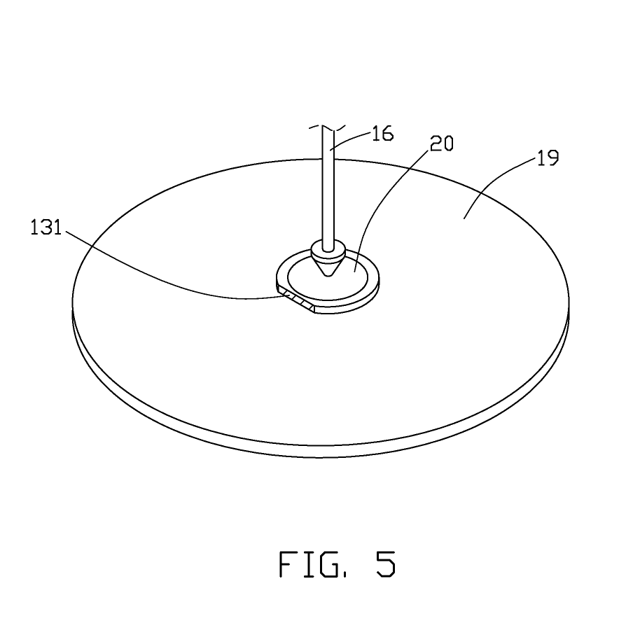

Referring to FIG. 4, a laser device 18 emits a laser beam 181 towards the joint 113 of the semi-finished molding lens 10 and forms a light spot (not shown) on the semi-finished molding lens 10. The laser beam 181 is perpendicular to a surface of the joint 113 of the semi-finished molding lens 10. The laser beam 181 heats the semi-finished molding lens 10 up to a temperature range of 60 centigrade degrees to 140 centigrade degrees. At the same time, a driving device 17 drives the laser device 18 to move along an X direction so that the light spot moves linearly on the semi-finished molding lens 10. In this way, the lens portion 11 is completely separated from the runner forming portion 12, thus obtaining a lens 20 (see FIG. 5). The driving device 17 can be a stepper motor or a servo motor. The driving device 17 controls a moving speed of the laser device 18 along the X direction in order to ensure smoothness of the cutting surface 131. The laser device 18 can be, for example, a gas laser device or a solid-state laser device. The gas laser device includes a carbon dioxide laser device, an inert gas laser device, and so on. The solid laser device includes an yttrium aluminium garnet (Nd:YVO₄) laser device.

Referring to FIG. 5, the lens 20 is sucked by the suction device 16, and carried to a lens collecting device 19, for example, a plate.

In the present embodiment, the lens portion 11 is separated from the semi-finished molding lens 10 by laser cutting rather than mechanical cutting (i.e., cutting employing the pair of hot scissors), which greatly decreased or eliminated stress generated thereon. The optical performance of the lens 20 is improved. Furthermore, no plastic particle is generated during the laser cutting, and, accordingly, the laser cutting prevents the lens 20 from getting polluted by the plastic particle. Therefore, the optical performance of the lens 20 is further improved.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. A method for cutting a semi-finished molding lens, the molding lens comprising a lens portion, a runner forming portion, and a joint, the joint being connected between the lens portion and the runner forming portion, the method comprising:
securing the molding lens on a base;
holding the lens portion by a suction force using a suction device; and
cutting the lens portion off from the runner forming portion using a laser beam.

2. The method as claimed in claim 1, wherein the laser beam is applied onto the molding lens and forms a light spot on the molding lens, and the light spot moves linearly on the molding lens.

3. The method as claimed in claim 1, wherein the laser beam is perpendicular to a surface of the joint.

4. The method as claimed in claim 1, wherein, the method further comprises the step of: placing the lens portion on a lens collecting device using the suction device after the lens portion is separated from the runner forming portion.

5. The method as claimed in claim 1, wherein the molding lenses heated up to a temperature of 60 centigrade degrees to 140 centigrade degrees using the laser beam.

6. The method as claimed in claim 1, wherein the molding lens is comprised of plastic.

7. The method as claimed in claim 1, wherein the suction device includes a suction nozzle.
